(19) United States
(12) Patent Application Publication
(10) Pub. No.: US 2016/0173869 A1
(43) Pub. Date: Jun. 16, 2016

(54) Multi-Camera System Consisting Of Variably Calibrated Cameras

(71) Applicant: Nokia Corporation, Espoo (FI)

(72) Inventors: Ting-Chun Wang, Berkeley, CA (US); Manohar Srikanth, Mountain View, CA (US)

(73) Assignee: Nokia Corporation

(21) Appl. No.: 14/570,090

(22) Filed: Dec. 15, 2014

(51) Int. Cl. H04N 17/00; H04N 5/225

(52) U.S. Cl. CPC H04N 17/002; H04N 5/2258

(57) ABSTRACT

An apparatus comprises a main camera configured to produce a high quality image; at least two auxiliary cameras configured to produce images of lower quality; and electronic circuitry linked to the main camera and the at least two auxiliary cameras, the electronic circuitry comprising a controller having a memory and a processor, the electronic circuitry configured to operate on data pertaining to the high quality image and pertaining to the images of lower quality to produce an enhanced high quality image as output data.

### BACKGROUND

1. Technical Field

The non-limiting embodiments disclosed herein relate generally to multimedia systems incorporating cameras and, more particularly, to systems and methods that utilize multiple cameras of similar and dissimilar types that capture images from different viewpoints and operate together or independently to produce high quality images and/or meta-data.

2. Brief Description of Prior Developments

Array cameras and light-field (plenoptic) cameras use microlens arrays to capture 4D light field information. Such cameras require significant computation to produce nominal high quality images even if a disparity map or refocus ability is not desired. In addition, the use of such cameras does not provide the flexibility to trade-off output quality, computation load, or power consumption.

### SUMMARY

The following summary is merely intended to be exemplary. The summary is not intended to limit the scope of the claims.

In accordance with one embodiment, an apparatus comprises a main camera configured to produce a high quality image; at least two auxiliary cameras configured to produce images of lower quality; and electronic circuitry linked to the main camera and the at least two auxiliary cameras, the electronic circuitry comprising a controller having a memory and a processor, the electronic circuitry configured to operate on data pertaining to the high quality image and pertaining to the images of lower quality to produce an enhanced high quality image as output data.

In accordance with another embodiment, a method comprises acquiring data from a main camera, the data pertaining to a high quality image; acquiring data from at least two auxiliary cameras, the data pertaining to at least two images of lower quality; combining the data pertaining to the high quality image and the data pertaining to the at least two images of lower quality; producing metadata pertaining to the acquired data; enhancing the high quality image with the metadata; and outputting the high quality image as image data.

In accordance with another embodiment, a method comprises acquiring data pertaining to a high quality image and data pertaining to at least two images of lower quality; using a dense correspondence algorithm to generate dense correspondence between the data pertaining to the high quality image and the data pertaining to the at least two images of lower quality; linking correspondence points from the dense correspondence generated to disparity values; grouping the disparity values into levels; computing a best fit homography transform of the disparity values for each level; and transforming the disparity values for each level to a high quality image.

### BRIEF DESCRIPTION OF THE DRAWINGS

The foregoing embodiments and other features are explained in the following description, taken in connection with the accompanying drawings, wherein:

FIG. 1 is a schematic representation of one example embodiment of a camera system comprising a main camera and two auxiliary cameras;

FIG. 2 is a flow representation of a method, in accordance with an example embodiment;

FIG. 3 is a flow representation of one example embodiment of a data processing step;

FIG. 4 is a schematic representation of another example embodiment of a camera system comprising a main camera and one auxiliary camera; and

FIG. 5 is a schematic representation of another example embodiment of a camera system comprising two main cameras.

### DETAILED DESCRIPTION OF EMBODIMENTS

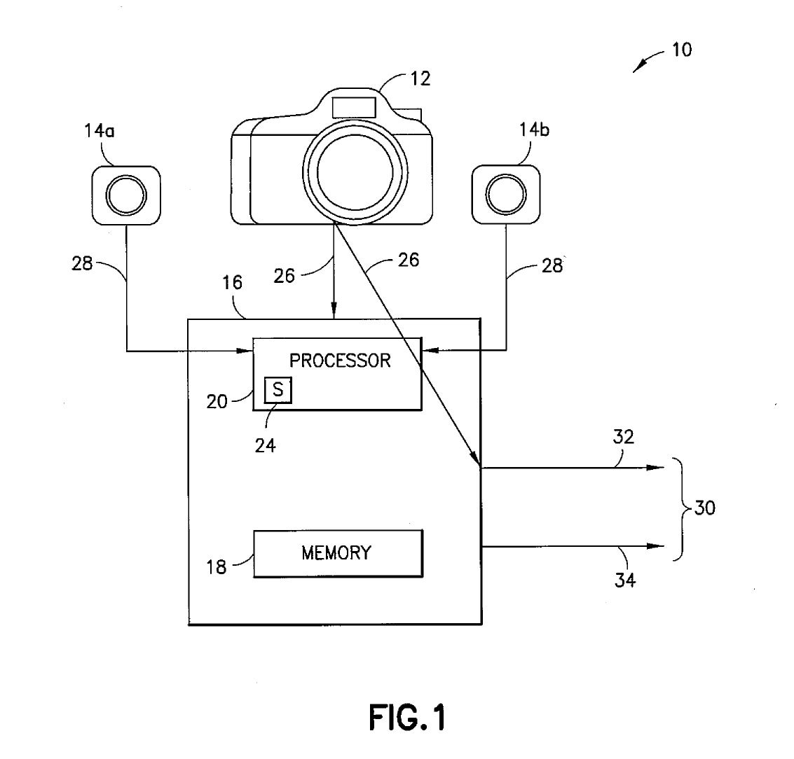

Referring to FIG. 1, one example embodiment of a multimedia system having a camera is designated generally by the reference number 10 and is hereinafter referred to as “system 10.” The system 10 may be embodied as a unitary camera apparatus having individual photography and/or videography components arranged in a single housing, or it may be embodied as separate or separable components remotely arranged. The system 10 may be integrated into any of various types of imaging devices such as point-and-shoot cameras, mobile cameras, professional cameras, medical imaging devices, cameras for use in automotive, aviation, marine applications, security cameras, and the like. Although the features will be described with reference to the example embodiments shown in the drawings, it should be understood that features can be embodied in many alternate forms of embodiments. In addition, any suitable size, shape, or type of elements or materials could be used.

In one example embodiment, the system 10 comprises a main camera 12 and two or more auxiliary cameras 14a and 14b, the main camera 12 and the auxiliary cameras 14a and 14b being disposed in communication with electronic circuitry in the form of a controller 16. More than two auxiliary cameras 14a and 14b may produce a denser light field. The example embodiments of the system 10 allow high quality image capture to produce optionally computable metadata such as disparity maps, depth maps, and/or occlusion maps. The high quality image is acquired from the main camera 12, while the disparity map (and other maps and/or metadata) is obtained using a combination of the images from the main camera 12 and images from the two or more auxiliary cameras 14a and 14b, which obtain images of lower quality. As used herein, high quality refers to high resolution (e.g., pixel resolution, which is typically about 12 megapixels (MP) to about 18 MP and can be has great as about 24 MP to about 36 MP), larger sensors (35 millimeters, APS-C, or micro 4/3), larger and superior optical lens systems, improved processing, higher ISO range, and the like. As used herein, lower quality refers to lower resolution as compared to the main camera 12 (e.g., cameras that are used in mobile phones have smaller sensors, resolutions of about 8 MP to about 12 MP, smaller lenses, very large depths of field (limited bokeh), and the like). Cameras of lower quality may be pinhole cameras where most parts of the images obtained therefrom are sharp. The example system 10 is more flexible than previous systems and addresses use-cases thereof more efficiently while at the same time requiring less computational power. For example, given a stereo image pair and a corresponding disparity map, one example method of using the system 10 may transfer a disparity map to a new view point from where an overlapping image is available. The configurations and settings of the main camera 12 and the auxiliary cameras 14a and 14b are optimized such that in the event that some parameters of the certain cameras are varied, the system 10 operates to produce expected results.

With regard to the two or more auxiliary cameras 14a and 14b, in one embodiment, both may be of the same type (for example, both may be color or both may be monochrome). In another embodiment, both of the two or more auxiliary cameras 14a and 14b may be slightly different (for example, one may be high resolution and the other may be low resolution (hence more sensitive to light since the pixels can be larger)). In another embodiment, the two or more auxiliary cameras 14a and 14b may be markedly different, where one is color and the other is monochrome or infrared (IR). In still another embodiment, where there are more than two of the auxiliary cameras 14a and 14b in the calibrated set, the auxiliary cameras may comprise a mixture of color, monochrome, IR, and the like.

As shown in FIG. 1, data pertaining to the images from the main camera 12 and the two or more auxiliary cameras 14a and 14b are linked by the controller 16, which comprises a memory 18 and a processor 20 having software 24 or other means for processing data. The processor 20 is capable of operating on the images (shown at 26) from the main camera 12 and the images (shown at 28) from the auxiliary cameras 14a and 14b in various ways to enhance the image of the main camera 12 and to produce output data 30 that is a combination of image data 32 and metadata 34. The memory 18 may be used for the storage and subsequent retrieval of data relevant to the output data 30. In one example embodiment, the processor 20 utilizes computational photography algorithms such as those based on dense correspondence and further utilizes best fit homography to transfer disparity levels determined from the captured images to a novel view point.

The main camera 12 is configured to acquire the high quality image 26, which in itself serves as a substantial portion of the overall photographic use-case. The auxiliary cameras 14a and 14b are configured to acquire the images 28 (or data pertaining to the images 28), which are combined with the image 26 (or data pertaining to the image 26) from the main camera 12 via the computational photography algorithms defined at least in part by the processor 20 to produce the metadata 34. Such metadata 34 includes, but is not limited to, disparity maps, depth maps, occlusion maps, defocus maps, sparse light fields, and the like. The metadata 34 can be used either automatically (for example, by autonomous processing by the processor 20) to enhance the high quality image 26 from the main camera 12, or it can be subject to user-assisted manipulation. The metadata 34 can also be used to gain additional information pertaining to the scene intended for capture by the main camera 12 and the auxiliary cameras 14a and 14b and hence can be used for efficient continuous image capture from the main camera 12 (for example, efficient autofocus, auto-exposure, and the like).

The unencumbered communication of intrinsic and extrinsic parameters between the cameras enables the processor 20 to perform accurate and efficient inter-image computations (such as disparity map computation) using the computational photography algorithms. In the system 10, the auxiliary cameras 14a and 14b are strongly calibrated with reference to each other, while the main camera 12 assumes varying parameters (for instance, focal length, optical zoom, optical image stabilization, or the like). As used herein, “strongly calibrated” refers to cameras having known parameters (that is, the intrinsic and extrinsic parameters are known for all operating conditions), and “weakly calibrated” refers to cameras having varying intrinsic and extrinsic parameters. Since the parameters of the main camera 12 are permitted to change during the operation of the system 10, only the approximate intrinsic and extrinsic parameters (between the main camera 12 and the auxiliary cameras 14a and 14b) leading to weak calibration are determined. This means that the inter-image computations between the main camera and the auxiliary cameras 14a and 14b become less efficient and inaccurate. To compensate for this decrease in efficiency and accuracy, the strong calibrations between the auxiliary cameras 14a and 14b can be used to combine obtained information with the weakly calibrated main camera to perform computations of increased efficiency and accuracy.

In some example embodiments, the requirement of strong calibration of the auxiliary cameras 14a and 14b relative to each other can be circumvented. However, doing so may lead to loss in computational efficiency and accuracy of the metadata 34. Since the strong calibration is generally only desired on the auxiliary cameras 14a and 14b and not on the main camera 12, such a requirement is readily amenable to cost effective manufacturing.

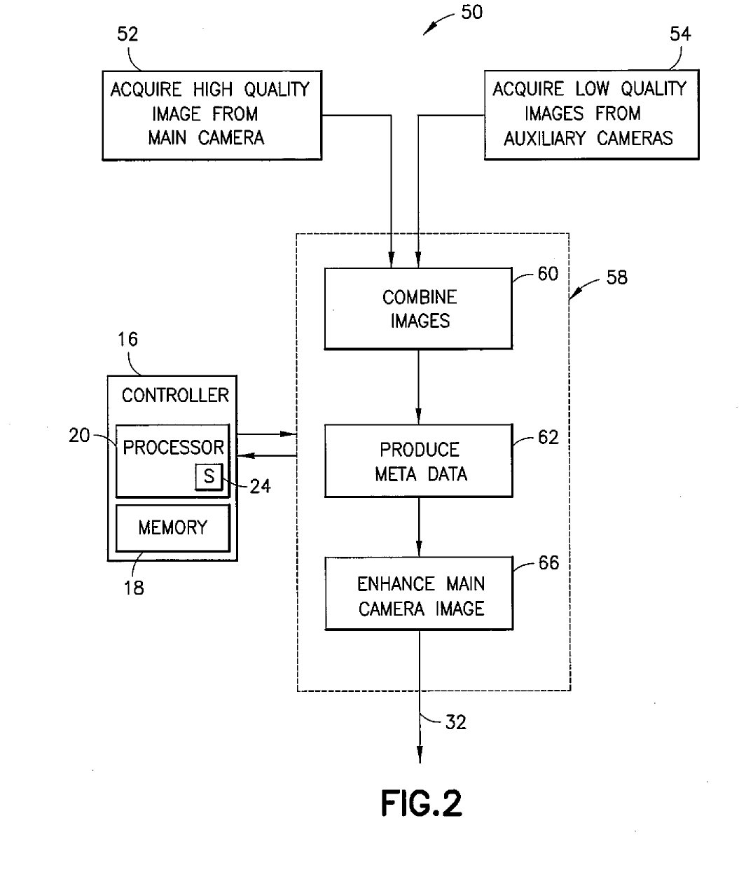

Referring now to FIG. 2, one example method of using the system 10 is designated generally by the reference number 50 and is hereinafter referred to as “method 50.” In method 50, the acquisition of data pertaining to the high quality image 26 from the main camera 12 is shown as the high quality image acquisition step 52. This high quality image acquisition step 52 is simultaneous or substantially simultaneous with a low quality image acquisition step 54 in which data pertaining to the low quality image 28 is obtained. Both the high quality image 26 and the low quality image 28 are then processed as data in a data processing step 58. In the data processing step 58, both the high quality image 26 and the low quality image 28 are combined in a combination step (for example, via the processor 20 of the controller 16). Metadata pertaining to the image data is produced in a metadata production step 62 (via the processor 20). One example method of producing the metadata involves inter-image computations using computational photography algorithms. The metadata is used to enhance the high quality image 26 of the main camera 12 in an enhancement step 66 (also via the processor 20). The enhancement of the high quality image 26 may be automatic (controlled by the processor 20) or, user-controlled. From the enhancement step 66, the enhanced high quality image is then output as the image data 32.

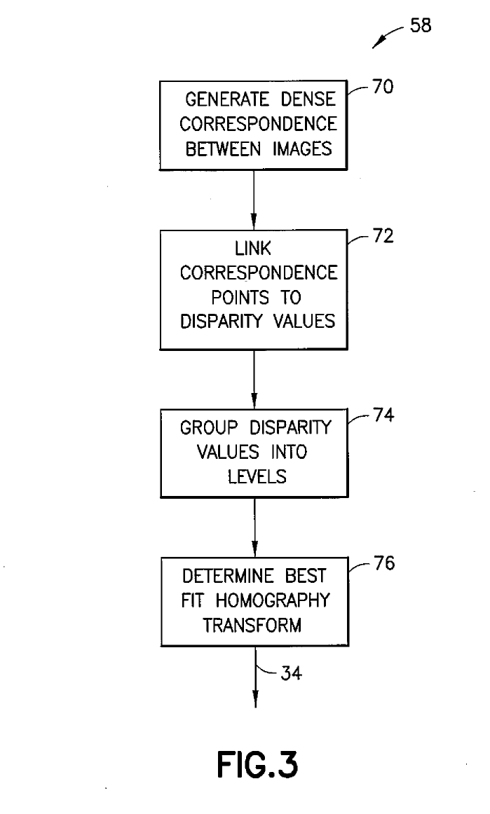

Referring now to FIG. 3, one example embodiment of the data processing step 58 is shown. In such a data processing step 58, the computational photography algorithm is a dense correspondence algorithm that is used to generate dense correspondence between data of the high quality image 26 from the main camera 12 and data of the stereo low quality images 28 from the auxiliary cameras 14a and 14b (from where the disparity map is already computed) in a generation step 70. From the dense correspondence generated, correspondence points are linked to disparity values in a linking step 72. The disparity values are then grouped into levels in a grouping step 74. For each level, a best fit homography transform is computed (as one example of homography transformation) in a computing step 76. Using the homography transform from the computing step 76, all disparity values within the given level are transformed (affine transformation) to the high quality image 26 of the main camera 12. While transforming the disparity values of each level, the dense correspondence algorithm starts from the level that corresponds to zero disparity and proceeds towards the level with highest disparity. This ensures that depth sorting occurs naturally at overlapping pixels. The proposed embodiment is likely to be more efficient (than-point-wise transfer) because only a finite disparity level exists in a typical stereo disparity, while each disparity level has many (e.g., thousands) of points.

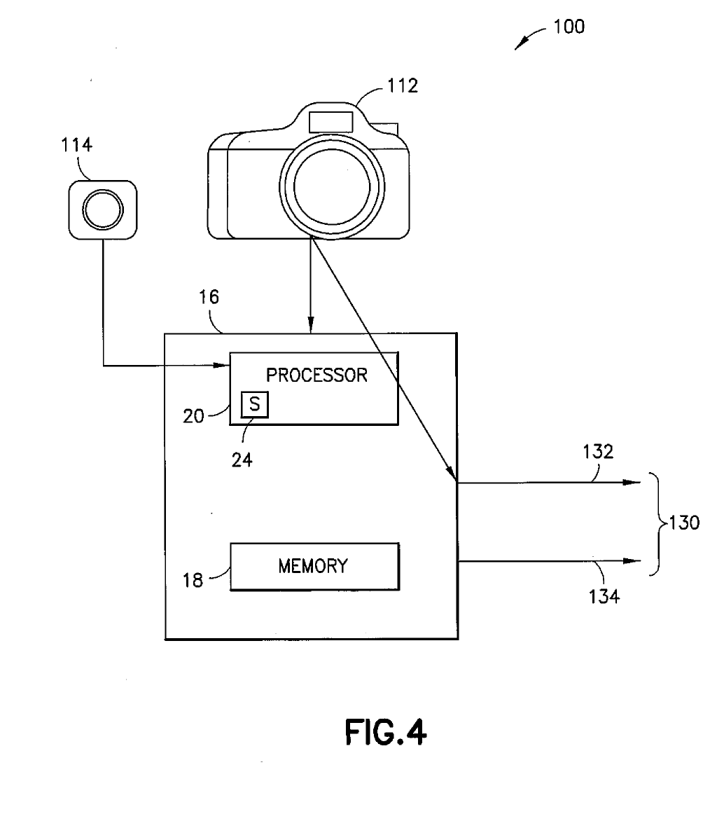

Referring now to FIG. 4, in another example embodiment, the objectives of the example embodiments of the system 10 disclosed herein can be accomplished by a system 100 that uses one main camera 112 and fewer (that is, a single) auxiliary camera 114. The images from the main camera 112 and the single auxiliary camera 114 are linked by the controller 16, which comprises a memory 18 and a processor 20 and software 24, the processor 20 being capable of operating on data pertaining to the images from the main camera 112 and data pertaining to the images from the single auxiliary camera 114 to produce output data 130 that is a combination of image data 132 and metadata 134. However, in such a system 100, the inaccuracies and computational efficiency (that occur due to weak calibration) may be prohibitively large as compared to those of system 10. Also, if excessively strong calibration is enforced, the system 100 might be too restrictive and not allow for the changing of the optical parameters such as zoom or focus of the main camera 112. In the case of two auxiliary cameras 14a and 14b as in system 10, the benefit to cost ratio is justifies the resources.

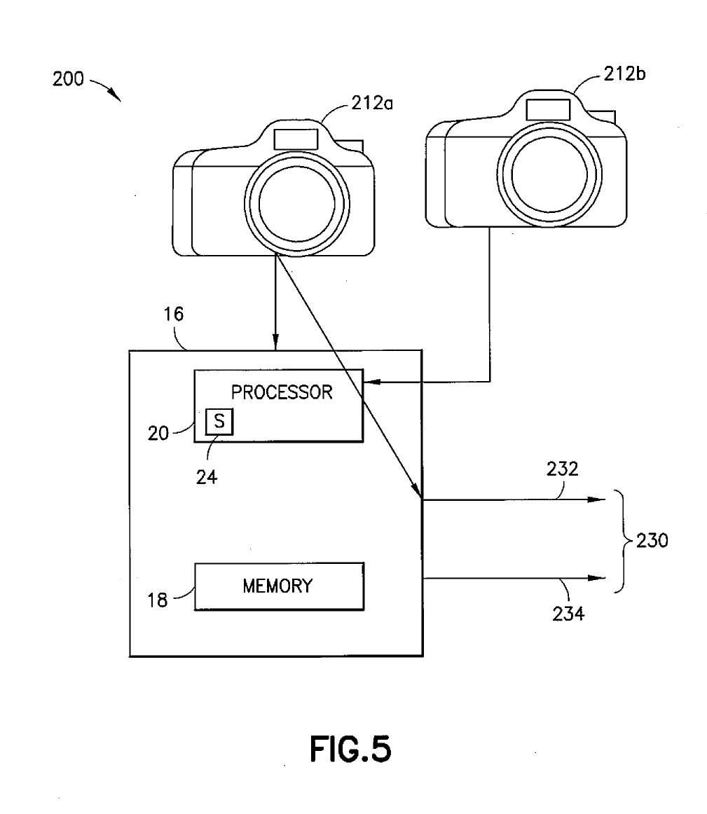

Referring now to FIG. 5, in another example embodiment as shown with regard to a system 200, it may be possible to use two high quality main cameras 212a and 212b that are strongly calibrated relative to each other to produce output data 230 that is a combination of image data 232 and metadata 234. However, in such a system 200, the overall cost may be much higher than using one main camera with two cheaper auxiliary cameras 14a and 14b as in system 10, and the system 200 might be too restrictive for creative use such as photography and/or videography.

Referring back to FIGS. 1 through 3, as compared to systems and methods that use array cameras and light-field (plenoptic) cameras, the system 10 as described herein allows for fine tradeoffs between image-quality, disparity-map-quality, overall cost of the system, and the use-cases of the system. Array cameras and light-field cameras and methods that utilize such cameras require significant computation to produce nominal high quality images even if a disparity map or refocus-ability is not desired. Such methods do not provide flexibility to trade-off the output quality, computation load, and power consumption. The ability to make tradeoffs is highly desirable for commercial imaging products that serve multiple purposes. Example purposes that such commercial imaging products serve include, but are not limited to, mobile photography, consumer and professional photography, automotive sensing, security/surveillance, and the like.

Furthermore, the system 10 as described herein produces a higher quality color image (as compared to previous systems) which in itself can be accepted as a final image in over 80% of use cases. However, with an optional additional computation, the auxiliary camera images are combined with the main camera image to produce a suitable quality disparity map (comparable to what previous systems are capable of producing) at a lower computational cost.

Moreover, most systems and methods that use array cameras and light-field cameras use direct warping of each individual disparity value using geometric information. This means that elements of an image are processed according to their image coordinates and outputs that are image coordinates in the resulting image are produced.

Additionally, the system 10 as described herein also capitalizes on the fact that many potential applications can be accomplished using a sparse light field.

The example systems as described herein may also provide higher degrees of control over image quality (in comparison to previous systems); zero-computation for nominal high-quality images; computation of disparity maps on an as-needed basis; automatic and semiautomatic image segmentation; occlusion map generation (auxiliary camera sees behind objects); increased blur (e.g., the use of bokeh) based on depth map; de-blurring of out-of-focus parts of an image; parallax views; stereo-3D images; and/or approximations of 3D models of a scene.

In one example embodiment, an apparatus comprises a main camera configured to produce a high quality image; at least two auxiliary cameras configured to produce images of lower quality as compared to the main camera; and electronic circuitry linked to the main camera and the at least two auxiliary cameras, the electronic circuitry comprising a controller having a memory and a processor, the electronic circuitry configured to operate on data pertaining to the high quality image and pertaining to the images of lower quality to produce an enhanced high quality image as output data.

The processor may utilize computational photography algorithms. The computational photography algorithms may utilize dense correspondence and best fit homography techniques. The output data produced may comprise a combination of high quality image data and metadata. The metadata may comprise one or more of disparity maps, depth maps, occlusion maps, defocus maps, and sparse light fields. The main camera may assume varying parameters related to the operation of the main camera. The at least two auxiliary cameras may have intrinsic and extrinsic operating parameters that are known for all operating conditions. The apparatus may comprise a point-and-shoot camera, a mobile camera, a professional camera, a medical imaging device, a camera for use in an automotive, aviation, or marine application, or a security camera.

In another example embodiment, a method comprises acquiring data from a main camera, the data pertaining to a high quality image; acquiring data from at least two auxiliary cameras, the data pertaining to at least two images of lower quality as compared to the high quality image; combining the data pertaining to the high quality image and the data pertaining to the at least two images of lower quality; producing metadata pertaining to the acquired data; enhancing the high quality image with the metadata; and outputting the high quality image as image data.

Producing metadata may comprise using computational photography algorithms embodied in a controller comprising a processor and a memory. Using computational photograph algorithms may comprise using a dense correspondence algorithm to generate dense correspondence between the acquired data pertaining to the high quality image and the acquired data pertaining to the at least two images of lower quality. A best fit homography transform may be computed from the dense correspondence generated. Enhancing the high quality image with the metadata may be one of controlled by a processor and controlled by a user.

In another example embodiment, a method comprises acquiring data pertaining to a high quality image and data pertaining to at least two images of lower quality as compared to the high quality image; using a dense correspondence algorithm to generate dense correspondence between the data pertaining to the high quality image and the data pertaining to the at least two images of lower quality; linking correspondence points from the dense correspondence generated to disparity values; grouping the disparity values into levels; computing a best fit homography transform of the disparity values for each level; and transforming the disparity values for each level to a high quality image.

Transforming the disparity values for each level to a high quality image may be an affine transformation. Transforming the disparity values for each level to a high quality image may comprise starting the dense correspondence algorithm from a level that corresponds to zero disparity and proceeds towards the level of highest disparity. Using the dense correspondence algorithm to generate dense correspondence may comprise using electronic circuitry comprising a controller having a memory and a processor. A dense correspondence map established by the data pertaining to a high quality image and the data pertaining to at least two images of lower quality may be used to reduce errors in a disparity map obtained using only the data pertaining to at least two images of lower quality.

In another example embodiment, a non-transitory computer readable storage medium, comprising one or more sequences of one or more instructions which, when executed by one or more processors of an apparatus, causes the apparatus to at least use a dense correspondence algorithm to generate dense correspondence between data pertaining to a high quality image and data pertaining to at least two images of lower quality as compared to the high quality image; link correspondence points from the dense correspondence generated to disparity values; group the disparity values into levels; and compute a best fit homography transform of the disparity values for each level. The disparity values for each level may be transformed to a high quality image.

In another example embodiment, an apparatus comprises a first camera configured to produce a high quality image; a second camera configured to produce images of lower quality; and electronic circuitry linked to the first camera and the second camera, the electronic circuitry comprising a controller having a memory and a processor, the electronic circuitry configured to operate on data pertaining to the high quality image and pertaining to the images of lower quality to produce an enhanced high quality image as output data. One of the first camera and the second camera may be strongly calibrated and the other of the first camera and the second camera may be weakly calibrated. In the alternative, the first camera and the second camera may be strongly calibrated relative to each other. When the first and second cameras are strongly calibrated relative to each other; defocus information in the first camera may be used as an additional cue to disambiguate disparity values to further enhance a disparity map.

Any of the foregoing example embodiments may be implemented in software, hardware, application logic, or a combination of software, hardware, and application logic. The software, application logic, and/or hardware may reside in the video player (or other device). If desired, all or part of the software, application logic, and/or hardware may reside at any other suitable location. In an example embodiment, the application logic, software, or an instruction set is maintained on any one of various conventional computer-readable media. A “computer-readable medium” may be any media or means that can contain, store, communicate, propagate, or transport instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications, and variances which fall within the scope of the appended claims.

1. An apparatus, comprising:
a main camera configured to produce a high quality image;
at least two auxiliary cameras configured to produce images of lower quality; and
electronic circuitry linked to the main camera and the at least two auxiliary cameras, the electronic circuitry comprising a controller having a memory and a processor, the electronic circuitry configured to operate on data pertaining to the high quality image and pertaining to the images of lower quality to produce an enhanced high quality image as output data;
wherein the processor utilizes computational photography algorithms that utilize dense correspondence and best fit homography techniques, the dense correspondence being based on data from the high quality image from the main camera and the images of lower quality from the at least two auxiliary cameras.

2. (canceled)

3. (canceled)

4. The apparatus of claim 1, wherein the output data produced comprises at least one of a high quality image data, metadata, and combination thereof.

5. The apparatus of claim 4, wherein the metadata comprises one or more of disparity maps, depth maps, occlusion maps, defocus maps, and sparse light fields.

6. The apparatus of claim 1, wherein the main camera assumes varying parameters related to the operation of the main camera.

7. The apparatus of claim 1, wherein the at least two auxiliary cameras have intrinsic and extrinsic operating parameters that are known for operating conditions.

8. The apparatus of claim 1, wherein the apparatus comprises a point-and-shoot camera, a mobile camera, a professional camera, a medical imaging device, a camera for use in an automotive, aviation, marine application, or a security camera.

9. A method, comprising:
acquiring data from a main camera, the data pertaining to a high quality image;
acquiring data from at least two auxiliary cameras, the data pertaining to at least two images of lower quality;
combining the data pertaining to the high quality image and the data pertaining to the at least two images of lower quality;
producing metadata pertaining to the acquired data;
enhancing the high quality image with the metadata; and
outputting the high quality image as image data;
wherein producing metadata comprises using computational photography algorithms embodied in a controller comprising a processor and a memory;
wherein using computational photography algorithms comprises using a dense correspondence algorithm to generate dense correspondence between the acquired data pertaining to the high quality image and the acquired data pertaining to the at least two images of lower quality; and
wherein a best fit homography transform is computed from the dense correspondence generated based on data from the high quality image from the main camera and the images of lower quality from the at least two auxiliary cameras.

10. (canceled)

11. (canceled)

12. (canceled)

13. The method of claim 9, wherein enhancing the high quality image with the metadata is one of controlled by a processor and controlled by a user.

14. A method, comprising:
acquiring data pertaining to a high quality image and data pertaining to at least two images of lower quality;
using a dense correspondence algorithm to generate dense correspondence between the data pertaining to the high quality image and the data pertaining to the at least two images of lower quality, the dense correspondence being based on data from the high quality image and the at least two images of lower quality;
linking correspondence points from the dense correspondence generated to disparity values;
grouping the disparity values into levels;
computing a best fit homography transform of the disparity values for each level; and
transforming the disparity values for each level to a high quality image.

15. The method of claim 14, wherein transforming the disparity values for each level to a high quality image is an affine transformation.

16. The method of claim 14, wherein transforming the disparity values for each level to a high quality image comprises starting the dense correspondence algorithm from a level that corresponds to zero disparity and proceeds towards the level of highest disparity.

17. The method of claim 14, wherein using the dense correspondence algorithm to generate dense correspondence comprises using electronic circuitry comprising a controller having a memory and a processor.

18. The method of claim 14, wherein a dense correspondence map established by the data pertaining to a high quality image and the data pertaining to at least two images of lower quality is used to reduce errors in a disparity map obtained using only the data pertaining to at least two images of lower quality.

19. A non-transitory computer readable storage medium, comprising one or more sequences of one or more instructions which, when executed by one or more processors of an apparatus, causes the apparatus to at least:
use a dense correspondence algorithm to generate dense correspondence between data pertaining to a high quality image and data pertaining to at least two images of lower quality;
link correspondence points from the dense correspondence generated to disparity values;
group the disparity values into levels; and
compute a best fit homography transform of the disparity values for each level.

20. The non-transitory computer readable storage medium of claim 19, comprising one or more sequences of one or more instructions which, when executed by one or more processors of an apparatus, further causes the apparatus to at least:
transform the disparity values for each level to a high quality image.

21. An apparatus, comprising:
a first camera configured to produce a high quality image;
a second camera configured to produce images of lower quality; and
electronic circuitry linked to the first camera and the second camera, the electronic circuitry comprising a controller having a memory and a processor, the electronic circuitry configured to operate on data pertaining to the high quality image and pertaining to the images of lower quality to produce an enhanced high quality image as output data;
wherein the processor utilizes computational photography algorithms that utilize dense correspondence and best fit homography techniques, the dense correspondence being based on data from the high quality image from the first camera and the images of lower quality from the second camera.

22. The apparatus of claim 21, wherein one of the first camera and the second camera is strongly calibrated and the other of the first camera and the second camera is weakly calibrated.

23. The apparatus of claim 21, wherein the first camera and the second camera are strongly calibrated′ relative to each other.

24. The apparatus of claim 23, wherein defocus information in the first camera is used as an additional cue to disambiguate disparity values to further enhance a disparity map.
